(19) United States
(12) Patent Application Publication
(10) Pub. No.: US 2023/0039994 A1
(43) Pub. Date: Feb. 9, 2023

(54) MULTI-STAGED EVENT PROCESSING BASED ON CLIENT DEVICE DATA

(71) Applicant: Uber Technologies, Inc., San Francisco, CA (US)

(72) Inventors: Akansha Kumar, San Francisco, CA (US); Ren Xu, San Francisco, CA (US); Tushar Agrawal, San Francisco, CA (US); Scott Lippert, San Francisco, CA (US); Mark Richmond, San Francisco, CA (US)

(21) Appl. No.: 17/884,452

(22) Filed: Aug. 9, 2022

Related U.S. Application Data
(63) Continuation of application No. 63/231,204, filed on Aug. 9, 2021.

(51) Int. Cl. G01C 21/34; G06Q 10/02

(52) U.S. Cl. CPC G01C 21/3438; G01C 21/343; G06Q 10/025

(57) ABSTRACT

A network computer system operates to determine one or more transport service parameters for an upcoming scheduled event at a mass egress location. One or more activities associated with the scheduled event are monitored to determine whether to update the one or more transport service parameters. Based at least in part on the one or more transport parameters, a set of relocation parameters is determined, including (i) an intermediate location where the service provider is to be located to provide the user with the transport service, and (ii) an intermediate arrival time when the first service provider is to arrive at the intermediate location before the pickup time. Based at least in part on a current location of a selected service provider and the intermediate arrival time, a relocation time when the service provider is to initiate travel to the intermediate location is determined.

### RELATED APPLICATIONS

This application claims benefit of priority to Provisional U.S. Patent Application No. 63/231,204, filed Aug. 9, 2021; the aforementioned priority application being hereby incorporated by reference in its entirety.

### BACKGROUND

A network-based service can enable users to request and receive various services through applications on mobile computing devices. The network-based service can assign a service provider to a requesting user based on the current location of the service provider and a start location specified by the requesting user or determined based on the current location of the requesting user.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example network system managing a network-based transport service, in accordance with examples described herein;

FIG. 2A is a flowchart diagram illustrating an example method of providing scheduled mass-egress transport service fulfillment using dynamic pre-match determination, in accordance with examples described herein;

FIG. 2B is a flowchart diagram illustrating an example pre-transport method for the pre-match mode in providing scheduled transport from an airport location, in accordance with examples described herein;

FIG. 2C is a flowchart diagram illustrating an example transport provision method for the pre-match mode in providing scheduled transport from a mass-egress location, in accordance with examples described herein;

FIG. 2D is a flowchart diagram illustrating an example transport provision method for the queue mode in providing scheduled transport from a mass-egress location, in accordance with examples described herein;

FIG. 2E is a flowchart diagram illustrating an example method for matching a service provider to a user that requires transport in connection with a scheduled event at a mass egress location, in examples described herein;

FIGS. 3A through 3P illustrate example user interfaces displayed within the user application and the service provider application to facilitate the request and fulfillment of scheduled transport services from mass-egress locations, in accordance with examples described herein;

FIG. 4 is a block diagram illustrating an example user device executing and operating a designated user application for communicating with a network system, according to examples described herein;

FIG. 5 is a block diagram illustrating an example service provider device executing and operating a designated service provider application for communicating with a network service, according to examples described herein; and

FIG. 6 is a block diagram that illustrates a computer system upon which examples described herein may be implemented.

### DETAILED DESCRIPTION

A network system is provided herein that manages a network-based transport service linking available service providers with requesting users throughout a given region (e.g., a metroplex such as the San Francisco Bay Area). In doing so, the network system can receive service requests for on-demand transport services from requesting users (e.g., a rider) via a designated service requester application executing on the users' mobile computing devices. Based on a location associated with the requesting user (e.g., a current location, an indicated start or rendezvous location), the network system can identify a number of available service providers (e.g., a driver) and transmit a service invitation to one or more service provider devices of the available service providers to fulfil the service request. The provider devices of the service providers receiving the invitations can present content that allows the service providers to either accept or decline the invitation.

In identifying a service provider to fulfill a given service request, the network system can identify a service provider based, at least in part, on a start location indicated in the service request. For example, the network system can determine a geo-fence surrounding the start location (or a geo-fence defined by a radius away from the start location), identify a set of candidate service providers (e.g., twenty or thirty service providers within the geo-fence), and select an optimal service provider (e.g., closest service provider to the service location, service provider with the shortest estimated travel time from the service location, service provider traveling to a location within a specified distance or specified travel time to the destination location, etc.) from the candidate service providers to fulfill the service request. According to examples provided herein, the network system can compile historical data for individual service requesters with regard to the network-based service. Thus, the network system can manage a service requester profile for each service requester indicating routine start and/or end locations (or regions), and/or routine routes (e.g., for a transportation service from home to work and/or vice versa) and preferred service types (e.g., transportation, delivery, mailing, etc.). In some examples, the network system can further synchronize with a service requester device to, for example, identify the service requester's contacts, the service requester's schedule and appointments, travel plans (e.g., a scheduled trip), and the like.

According to embodiments, the user (or rider) device by executing the user application thereon, the provider device by executing the service provider application thereon, and/or the network system (implemented on one or more servers) can facilitate the fulfillment and provision of a scheduled network-based transport service from mass-egress locations such as airports, mass transit stations, and event venues by performing dynamic pre-match determination. While examples described herein describe the technology in connection with mass-egress locations, alternative embodiments contemplate that scheduled network-based transport services can be provided in any location or region, irrespective of how crowded or vacant the location or region is.

In one aspect, the user application and/or the network system can determine, based on the user's interactions with the user application, a current or past transport request, and/or other contextual information, to trigger the process in facilitating the scheduled transport service. As one example, the user's interactions with the user application (e.g., input of an airport as the service location and a future date and/or time as the time to receive transport service) can indicate that the user is trying to schedule a future transport service from a mass-egress location and, in response, the process for facilitating the scheduled network-based transport service can be triggered. As another example, the process can be triggered based on the user requesting transport (or a recent transport request) to the mass-egress location, which can indicate that the user will, in the near future, require return transport services from the location. Furthermore, contextual information—such as information indicating the occurrence of a large attendance event (e.g., concert, sporting event, etc.) at a venue—can trigger the process to provision of scheduled network-based transport service from the venue.

According to embodiments, the user can be prompted to provide information that can be relevant to the scheduled transport service from the mass-egress location. For instance, for a scheduled transport from an airport, the user can be prompted, on a user interface presented within the user application executing on the user device, to enter information relating to the user's flight such as the date of the flight and the flight number. The network system can utilize the provided information to monitor for transport events such as the arrival, departure, delay, cancellation, etc. of the flight at a particular location. The current or up-to-date information retrieved by the network system relating to the transport events can be used to update the fulfillment and provision of the transport service scheduled for the user. For example, if the transport event is determined to be delayed or cancelled, the network system can use the data obtained in connection with the transport event to automatically perform remedial actions to minimize disruptions in the scheduled transport service for the requesting user and/or the pre-matched service provider.

In another aspect, the network system can selectively operate, based on the dynamic pre-match determination, in a pre-match mode or a queue-based mode in identifying and matching service providers with the requesting user. In the pre-match mode, the network system can pre-match the scheduled request with a service provider at a time prior to a transport event (e.g., based on a configured date or time, such as 12 hours or 24 hours prior to the user's flight landing or arriving at a particular location). The service provider can be identified in a broader geographic region that includes or is near the mass-egress location. For instance, for pre-matching for a scheduled transport from San Francisco International Airport, the network system can identify a service provider that is associated with the San Francisco Bay Area. The network system can transmit a relocation request to the provider device of the pre-matched service provider to travel to an intermediate location (e.g., an airport waiting lot). The relocation request can be based on the monitored travel event. For instance, the network system can transmit the relocation request ahead of the user's flight landing time such that the pre-matched service provider arrives at the airport waiting at approximately the same time as the user's flight landing. When the user is ready to receive transport service, the user can provide an indication (e.g., by interacting with a notification presented on the user device, providing an input within the user application, etc.) using the user device. In response, the network system can transmit a user pickup request/invitation to the provider device of the pre-matched service provider.

In the queue-based mode, the network system can identify a service provider for the scheduled transport from a queue of service providers (e.g., an airport queue) associated with the mass-egress location that is used in the service provider selection process in fulfilling on-demand requests for transport from the mass-egress location. A service provider's position within the queue can establish priority (e.g., first in, first out) during the matching process to fulfill transport requests from the mass-egress location. In various aspects, the queue can be a virtual construct stored in memory and managed by the network system and a service provider can be entered into the queue based on location data provided by the provider device of the service provider. In one example, the network system can monitor the location data of the provider device and, based on detecting that the service provider has entered within the premises of San Francisco International Airport (SFO), the provider device can be triggered to present a notification or a confirmation user interface asking if the service provider would like to enter the queue of service providers for providing transport service out of SFO. The service provider can be taken out of the queue in response to detecting that the service provider has exited the airport premises or has entered an offline state with respect to the network-based transport service.

Because service providers in the queue of a mass-egress location are generally within or approximate to such a location, the network system can, in the queue-based mode, identify a service provider for the scheduled transport for the requesting user relatively contemporaneously with the transport event of the requesting user. For example, in the queue-based mode, the network system can identify a service provider for a scheduled transport from an airport location approximately the same time (e.g., 10 minutes prior to) the monitored flight landing time of the requesting user. If the service provider accepts the invitation to fulfill the scheduled transport service for the requesting user, the network system can transmit a relocation request to the service provider to provide directions to the service provider to relocate (if necessary) to an intermediate location (e.g., an airport waiting lot closest or with the least ETA to the location for picking up the requesting user). In some instances, the service provider, who is identified from the queue, is already positioned at the desired intermediate location. In such instances, a relocation request need not be transmitted. In other instances, the service provider may be in the queue and waiting at a different location than the intermediate location (e.g., an airport can have multiple waiting lots) and a relocation request can be transmitted to the service provider to reposition the service provider to the intermediate location. And in response to the requesting user providing an indication via the user device that the user is ready to receive the scheduled transport service, the network system can transmit a pickup request to the service provider to direct the service provider to relocate from the intermediate location to the pickup location or the location of the requesting user.

In managing and facilitating the network-based transport service, including the provision of scheduled transport services from mass-egress locations, the network system can maintain, manage, and dynamically update data records representing profiles of users and service providers and data records corresponding to queues of service providers associated with various locations such as airports, mass transit stations, and event venues. In particular, to maintain and update service provider queues, the network system can continuously communicate with service providers to receive location data and can automatically classify a service provider as entering the queue associated with a particular service location on the basis of the service provider being located within a geofence or geographic boundary near the service location (or within the service location such as an airport waiting lot inside or near an airport). Moreover, the network system can utilize APIs provided by third party data sources to retrieve and monitor information relating to events that may be relevant to the user's scheduled transport service. For instance, the network system can utilize APIs provided by airlines or other data aggregators to retrieve and monitor flight status information by accessing databases and streaming data sources of such information. In response to the information retrieved from data sources, various aspects of the scheduled request for the network-based transport service can be automatically managed and modified based on the retrieved information. For instance, based on retrieved information indicating an event delay, the network system can automatically re-schedule the surfacing of notifications on the service provider device that prompt the service provider to relocate to the intermediate location.

In other aspects, the provision of scheduled transport services at mass-egress locations based on dynamic pre-match determining improves the computational efficiency of the network system to match available service providers with users requesting scheduled transport services. By dynamically determining a mode of operation based on metrics relating to expected numbers of available service providers at the service location and/or expected numbers of requests at the service location, the network system can fulfill the request for scheduled transport in a manner that avoids excess or wasted computing resources. For instance, by provisioning a scheduled transport in the pre-matched mode, the network system can avoid situations in times of low supply when few service providers are available at the service location to fulfill requests at the service location (including the scheduled transport service) and the network system is continuously performing computationally intensive tasks to communicate with service provider devices in areas further away from the service location to invite those service providers to fulfill the scheduled transport service at the service location. By leveraging known information relating to the user's plans, the network system can perform such pre-match and a service provider can be offered to fulfill the request well in advance, and the aforementioned computational overhead and waste can be avoided.

According to additional embodiments, a network computer system operates to determine one or more transport service parameters for an upcoming scheduled event at a mass egress location, where the one or more service parameters include a pickup time when a transport service is to initiate for the user. One or more activities associated with the scheduled event are monitored to determine whether to update the one or more transport service parameters. A first service provider is selected to transport the user from the mass egress location in connection with the upcoming scheduled event. Based at least in part on the one or more transport parameters, a set of relocation parameters is determined, including (i) an intermediate location where the service provider is to be located to provide the user with the transport service, and (ii) an intermediate arrival time when the first service provider is to arrive at the intermediate location before the pickup time. Based at least in part on a current location of the first service provider and the intermediate arrival time, a relocation time when the service provider is to initiate travel to the intermediate location is determined. At the relocation time, a first notification is transmitted to a computing device of the first service provider to direct the first service provider to the intermediate location. Further, based at least in part on the pickup time, at a second time, a second notification is transmitted to the computing device of the first service provider to direct the first service provider from the intermediate location to a pickup location within the mass egress location, to initiate the transport service from mass egress location.

Still further, in other examples, one or more transport service parameters are determined for an upcoming scheduled event at a mass egress location, where the one or more service parameters including a pickup time when a transport service is to initiate for the user. A provisioning level of service providers for the mass egress location during a time interval of the scheduled event. One of a pre-match process or a queue process is implemented to match the transport service to one of a plurality of service providers, based at least in part on the predicted provisioning level. The matched transport provider is detected as being positioned at an intermediate location in advance of the start time. A notification is transmitted to a computing device of the matched service provider, to direct the matched service provider from the intermediate location to a pickup location within the mass egress location.

As used herein, the terms “optimize,” “optimization,” “optimizing,” and the like are not intended to be restricted or limited to processes that achieve the most optimal outcomes. Rather, these terms encompass technological processes (e.g., heuristics, stochastics modeling, machine learning, reinforced learning, Monte Carlo methods, Markov decision processes, etc.) that aim to achieve desirable results. Similarly, terms such as “minimize” and “maximize” are not intended to be restricted or limited to processes or results that achieve the absolute minimum or absolute maximum possible values of a metric, parameter, or variable.

As used herein, a computing device refers to devices corresponding to desktop computers, cellular devices or smartphones, personal digital assistants (PDAs), laptop computers, virtual reality (VR) or augmented reality (AR) headsets, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, VR or AR devices, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Descriptions

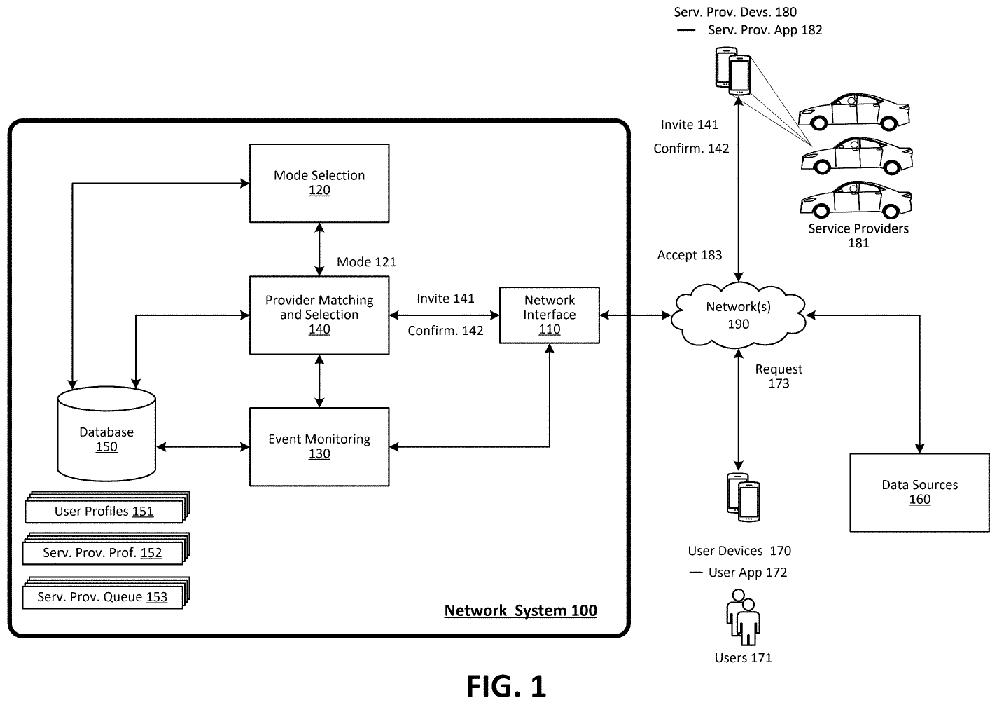

FIG. 1 is a block diagram illustrating an example network system managing a network-based service, in accordance with examples described herein. The network computer system 100 can implement and manage a network service that connects requesting users 171 with service providers 181 that are available to service the users' requests for service. The network service can provide a platform that facilitates services to be requested and provided between requesting users 171 and available service providers 181 by way of a user application 172 executing on the user devices 170 and a service provider application 182 executing on the service provider devices 180. As used herein, a user device 170 and a service provider device 180 can correspond to a computing device with functionality to execute a designated application (e.g., a user application, a provider application, etc.) associated with the network service managed by the network computer system 100. According to embodiments, the user device 170 and the service provider device 180 can correspond to mobile computing devices, such as smartphones, tablet computers, VR or AR headsets, on-board computing systems of vehicles, smart watches, and the like.

The network computer system 100 can include a network interface 110 to communicate with user devices 170 and service provider devices 180 over one or more networks 190 via the designated applications (e.g., user application 172, service provider application 182, etc.) executing on the devices. The network computer system 100 can further communicate with other data sources 160 over the networks 190 to monitor and/or retrieve information relevant to events that may affect the provision of scheduled transport services for users.

According to examples, a requesting user 171 wishing to utilize the network service can launch the user application 172 and transmit a request for service (e.g., request 173) over network 190 to the network computer system 100. In certain implementations, the requesting user 171 can view multiple different service types managed by the network computer system 100, such as ride-pooling, a basic or economy service type, a luxury vehicle service type, a van or large vehicle service type, a professional service provider service (e.g., in which the service providers are certified), a self-driving vehicle service, a rickshaw service, and the like. The network computer system 100 can utilize the service provider locations to provide the user devices 170 with ETA data of proximate service providers for each respective service. For example, the user application 172 can enable the user 171 to scroll through each service type. In response to a soft selection of a particular service type, the network computer system 100 can provide ETA data on a user interface of the user application 172 that indicates an ETA for the service type and/or the locations of all proximate available vehicles for that service type. As the user scrolls through each service type, the user interface can update to show visual representations of vehicles for that service type on a map centered around the user 171 or a start location set by the user. The user can interact with the user interface of the user application 172 to select a particular service type, and transmit a request 173.

In various embodiments, the network computer system 100 can include a mode selection 120, which can determine mode indication 121 that indicates whether a given scheduled service request from a mass-egress location (e.g., request 173) should be provisioned in accordance with a pre-matched mode or a queue mode. A service provider 181 presented with an invitation 141 can accept or decline the invitation 141 via the service provider application 182. The provider device 180 can transmit an acceptance 183 in response to the service provider 181 accepting the invitation 141 or offer. The acceptance 183 can be received by the network computer system 100 and processed by the provider matching and selection 140.

The network computer system 100 can further include event monitoring 130 to communicate with third party data sources 160 to monitor and/or retrieve updates pertaining to events that may affect the user's scheduled transport request. For example, the event monitoring 130 can communicate with one or more third party data sources 160 (e.g., via APIs provided by airlines to and/or flight data aggregators to access databases or streaming data of flight information) to retrieve up-to-date flight status information relating to a flight the user is taking. The flight status information can be used by the network computer system 100 to manage the scheduled transport service as described herein.

The network computer system 100 can further include a database 150 that can maintain records for user profiles 151, service provider profiles 152, and service provider queues associated with various service locations 153. In particular, service provider queues 153 can correspond to virtual queues managed by the network computer system 100 in managing priority of service providers in fulfilling transport services at various locations such as airports, event venues, mass transit locations, etc.

Methodology

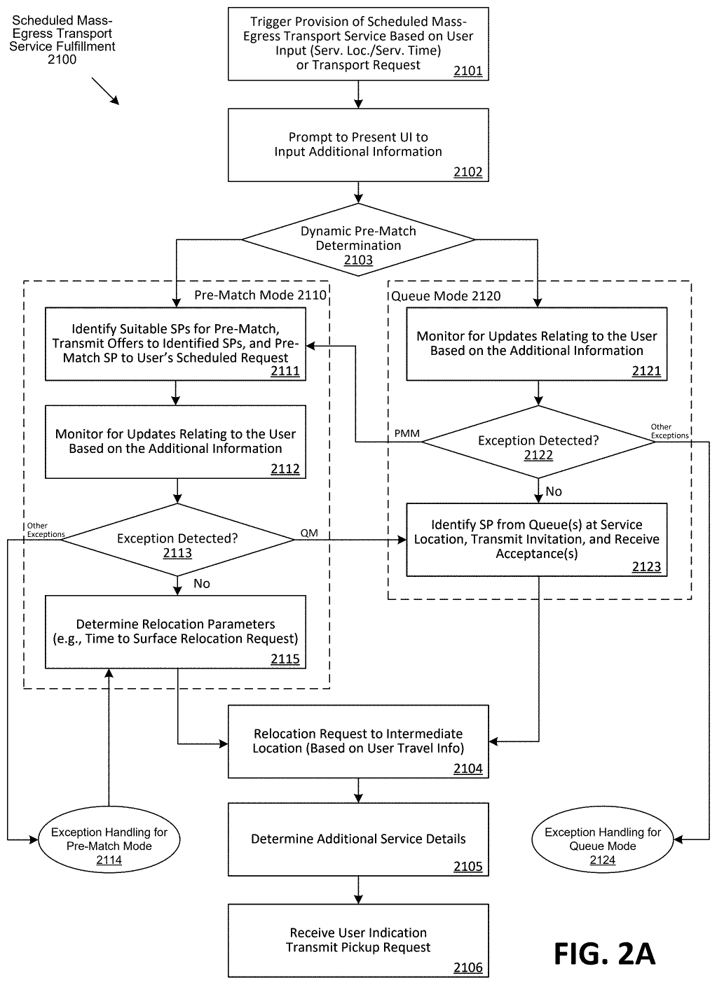

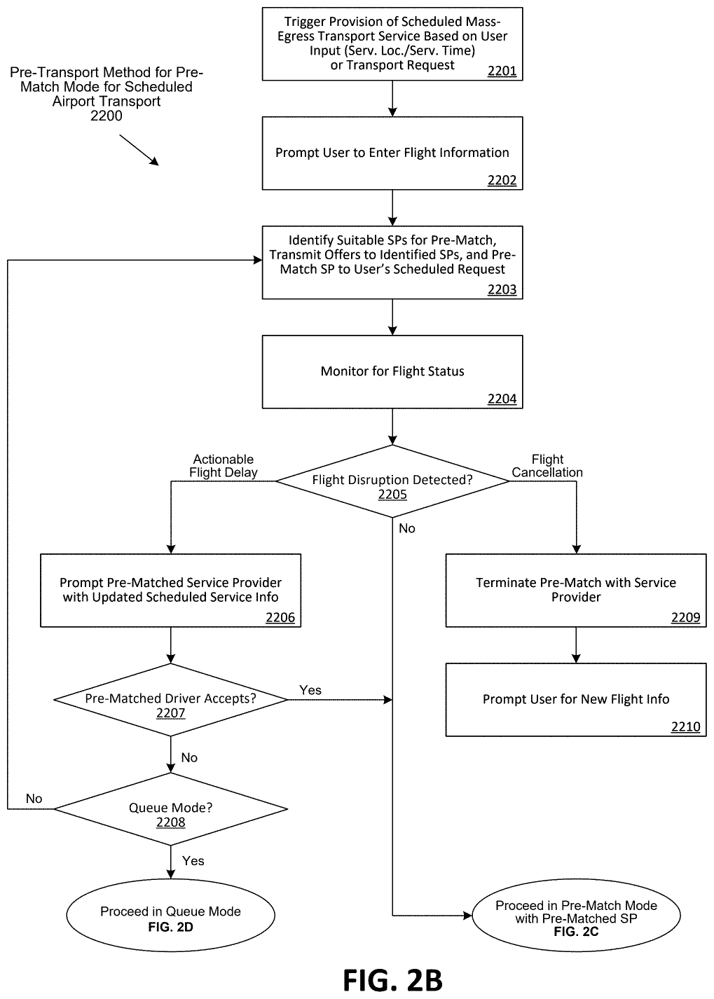

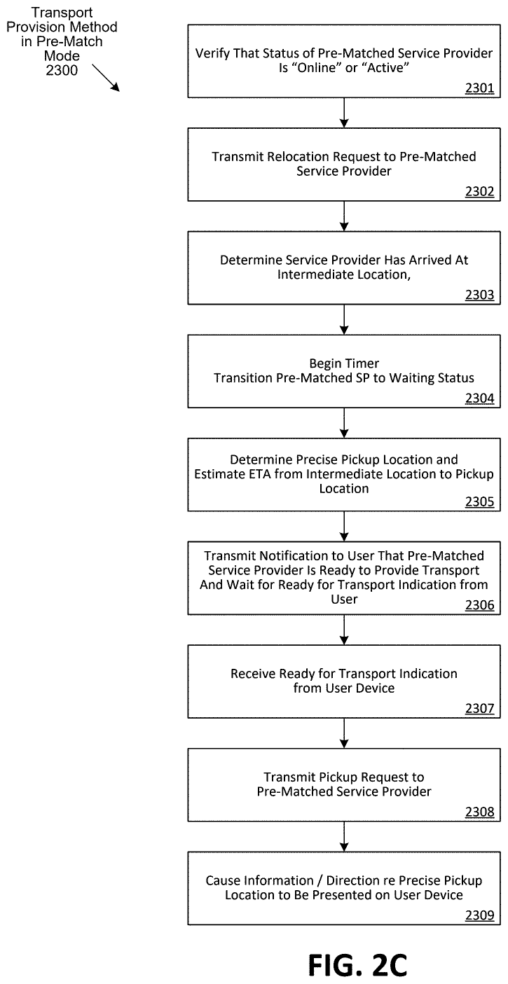

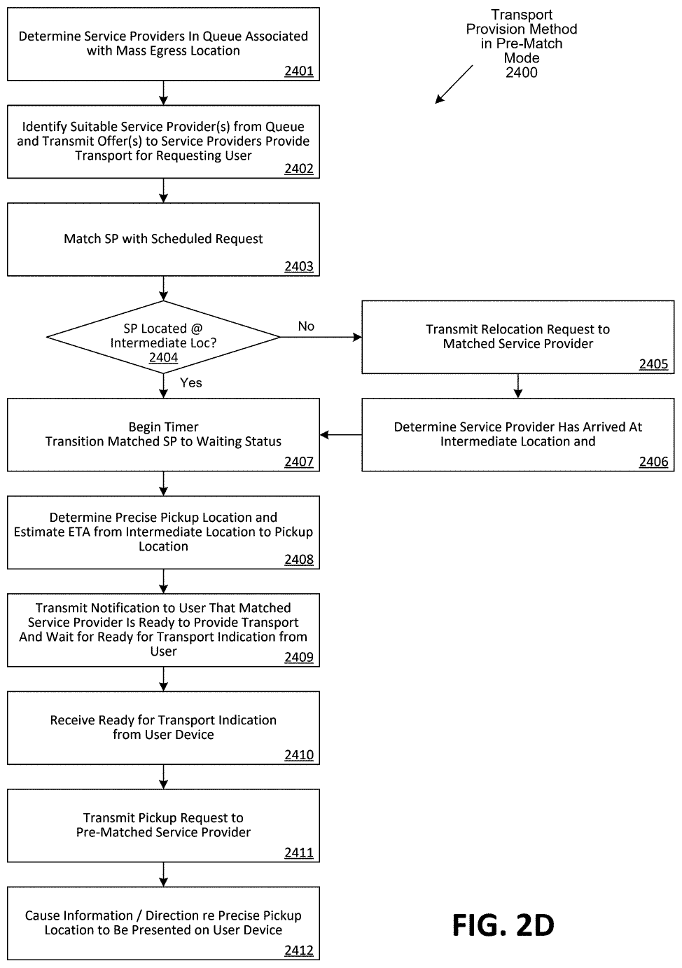

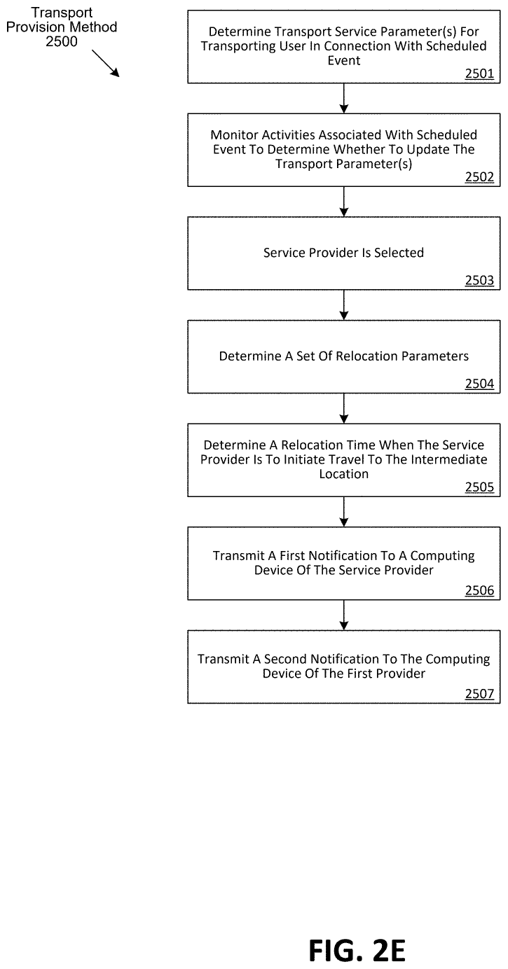

FIG. 2A is a flowchart diagram illustrating an example method of providing scheduled mass-egress transport service fulfillment using dynamic pre-match determination, in accordance with examples described herein. In the below discussion of FIG. 2A, reference may be made to features and examples shown and described with respect to FIG. 1. For instance, the method 2100 illustrated in and described with respect to FIG. 2A can be performed by the exemplary network computer system 100 illustrated in FIG. 1.

Referring to FIG. 2A, the scheduled mass-egress transport service fulfillment 2100 can be triggered at step 2101 based on the user's interactions with the user application executing on the user device, a current or past transport request, and/or other contextual information. As one example, the user can trigger the method 2100 by interacting with the user application by entering a service location (e.g., a start location of the network-based transport service where the service provider is to rendezvous with and pick up the requesting user) and a service time (e.g., a time at which the service provider is to rendezvous with the requesting user). For instance, the user application and/or the network computer system 100 can determine, based on the user inputs or interactions with the user application, that the user is attempting to schedule a future service for transport from a specific, predetermined mass-egress location such as an airport terminal, a train station, or other mass transit location.

Further, the user application and/or the network computer system 100 the future transport service may be made in connection with a scheduled event (e.g., flight, concert or venue event, etc.). For example, the user application and/or the network computer system 100 can infer that the future service is being made in connection with a scheduled flight, based on the determination that the service location provided by the user is an airport. Likewise, the user application and/or the network computer system 100 can infer that a future service for transport will involve the mass egress location (e.g., airport), based on user interactions which specify or otherwise indicate a scheduled event that is known to take place at the mass egress interaction (e.g., user schedules a flight or checks on a flight).

As an addition or as an alternative, the user application and/or the network computer system 100 can trigger the method 2100 to schedule a future service for transport for the user based on a current or past service request of the user. For instance, based on the user requesting transport service to a mass-egress location, the user's likelihood to request return transport service from the location at a future time can be inferred. In response, the user application and/or the network computer system 100 can automatically prompt the user (e.g., via a push notification presented on the user device, via an in-app notification presented within the user application, etc.) to schedule a transport service from the mass-egress location and input additional information to facilitate the provisioning of the scheduled transport service. For example, if the user requests a transport service to an airport terminal, the user can be automatically prompted to schedule a transport service from the airport terminal for a future service time.

Some locations can be selectively classified as mass-egress locations based on contextual information and/or a service time. For instance, a venue (e.g., a convention center, a stadium, a performing arts center, etc.) can be classified as a mass-egress location based on contextual information indicating that a high attendance event (e.g., a sporting event, a concert, a convention, etc.) is occurring at the venue around the service time the user is requesting for a scheduled transport from the venue. If the user schedules service for other times from the venue (e.g., when no events are scheduled to take place at the venue), the process 2100 may not be triggered.

In response determining to provision the service request in accordance with method 2100, at step 2102, the user can be prompted within the user application to provide additional information. The user application can intelligently determine the types or categories of additional information to be provided by the user based on the service location. For example, if the service location is an airport, the user application can prompt the user to input flight or travel information such as the flight number the user is planning on taking to travel to the airport as well as the date of the flight. If the service location is a train station, the user can be prompted to enter the train number and the date of the train service. In certain implementations, the user can be prompted to enter his or her entire travel itinerary including information relating to connecting flights taken prior to the final leg of the trip to the service location airport.

The network computer system 100 at step 2103 can perform dynamic pre-match determination to determine whether to fulfill the scheduled mass-egress transport service in the pre-match mode 2110 or in the queue mode 2120. This determination can be based on an anticipated, predicted or expected provisioning level, for a geographic region of the mass egress location. Further, the determination can be made for a relevant time period, such as a time interval that coincides with the time of the scheduled events. In examples, the determination of the provisioning level can be based on measure(s) of supply of service providers available to provide service at the service location at the requesting user's scheduled service time (e.g., service providers at an airport queue) and/or an anticipated or expected measure(s) of demand of users requesting transport services at the service location at the requesting user's scheduled service time. For instance, if the network computer system 100 can analyze historical information relevant to the service location to model measures of supply and demand that vary with time and days of the week. If it is determined that the queue of service providers associated with the service location is typically sufficient at the requested service time to meet the demands of requesting users, the network computer system 100 can determine to proceed in the queue mode 2120. On the other hand, if it is determined that the queue of service providers is typically insufficient, the network computer system 100 can determine to proceed in the pre-match mode 2110.

When the determination of the provisioning level is made for a future time interval, the provisioning level determinations can be based on predictions of supply (e.g., number of available service providers in the reaching a vicinity of the egress location) and demand (e.g., number of users who may request or need transport at the relevant time interval). The network computer system 100 can utilize, for example, historical information to predict provisioning levels for the future time interval. The predicted provisioning levels may form the basis of whether the network computer system implements the pre-match mode or the queue mode, for matching the user with a service provider, as described with various examples.

The measures of supply and/or demand can include one or more of: an expected number of available service providers in a queue associated with the service location at the requested service time, an expected number of requesting users at the requested service time, an anticipated ratio of available service providers to users at the requested service time, and/or an anticipated or typical wait time for users requesting service from the service location at the requested service time.

In the pre-match mode 2110, the network computer system 100 identifies suitable service provider(s) for pre-match, transmits offers to the identified service provider(s), and pre-matches a service provider with the user's request for scheduled transport service in advance of the user arriving at the service location. The pre-matching of service providers with the scheduled request can be performed in advance of the service time requested by the user (e.g., 12 hours, 24 hours in advance of the service time) to allow the pre-matched service provider time to plan the provisioning of the request. Based on implementation, the window to identify pre-match service providers can depend on the requested service time to ensure that service providers have sufficient opportunity to review the offer or invitation. For instance, for a 6 A.M. service time, the network computer system 100 can identify pre-match service provider candidates and transmit offers the night before (e.g., at least 12 hours in advance); whereas for a 6 P.M. service time, the network computer system 100 can identify pre-match service provider candidates 6 hours before the service time. The network computer system 100 can identify suitable service providers from a broader geographical region that includes or is near the service location. For instance, for scheduled service from SFO, the network computer system 100 can identify service providers that are located in or associated with the broader San Francisco Bay Area (e.g., service providers that typically provide transport services within the region, service providers that have an address on file located within the region, etc.). Service providers can be identified based on their indicated preferences and/or based on historical records of transport services provided. For example, a service provider can be identified for a particular scheduled request on the basis of a preference inputted via the service provider application that the service provider would like to be pre-matched with requests at the service location at given times on given days of the week. As an alternative or in addition, the service provider can be identified on the basis of the service provider's record indicating the service provider is typically in an online or active mode with respect to the network-based transport service at the requested service time. The network computer system 100 can further identify a suitable service provider based on record data indicating that the service provider typically provides transport from the service location requested by the requesting user at or around the requested service time (e.g., 4 P.M on Fridays).

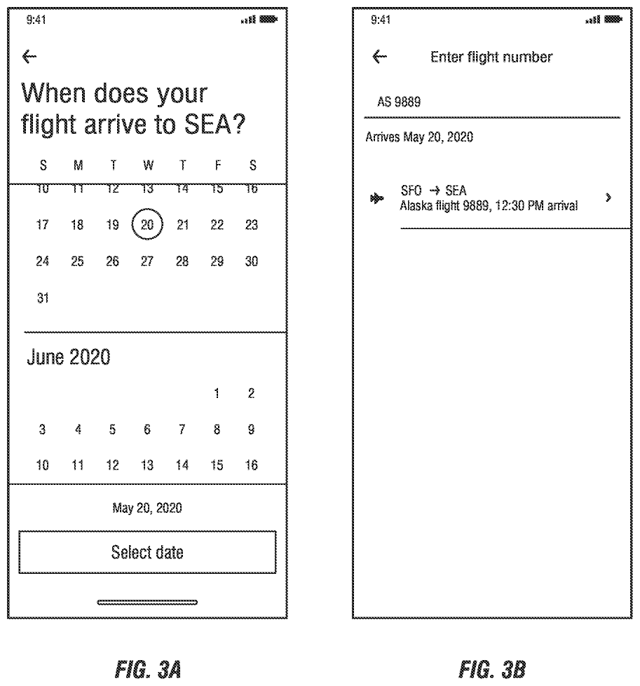

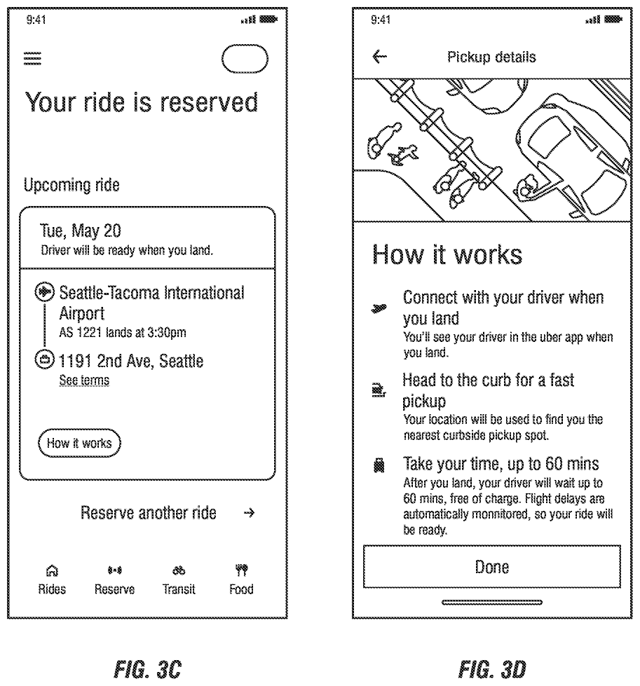

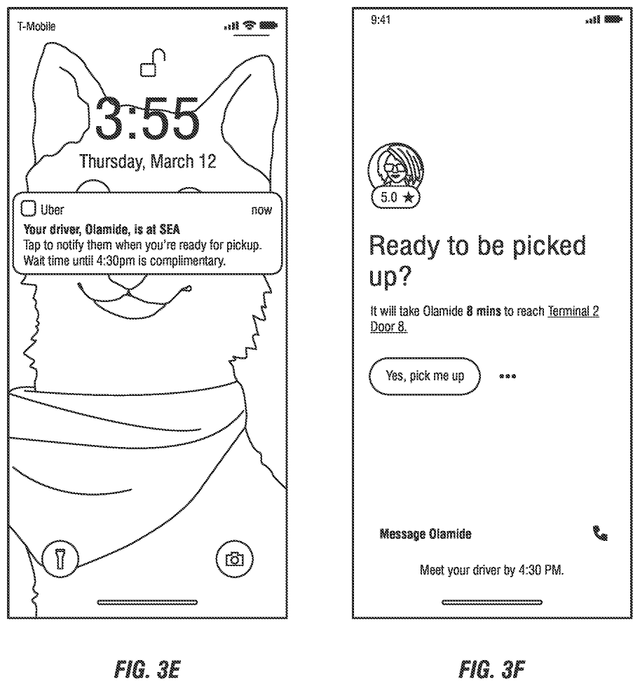

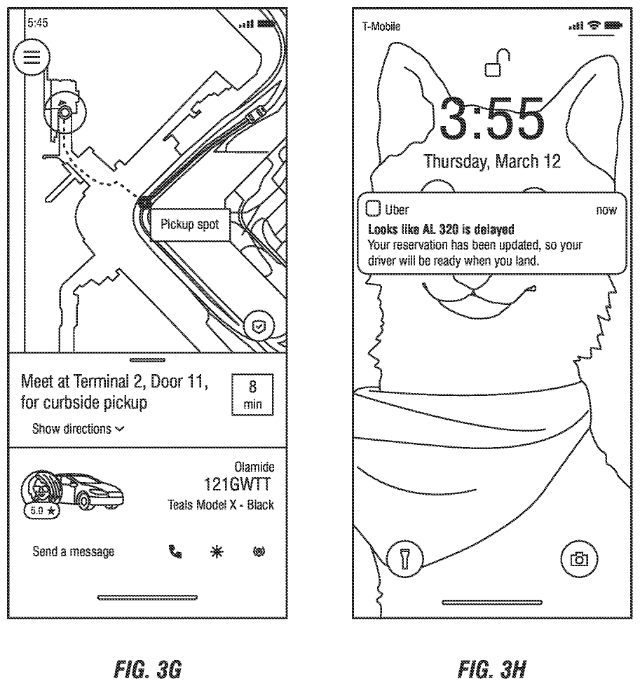

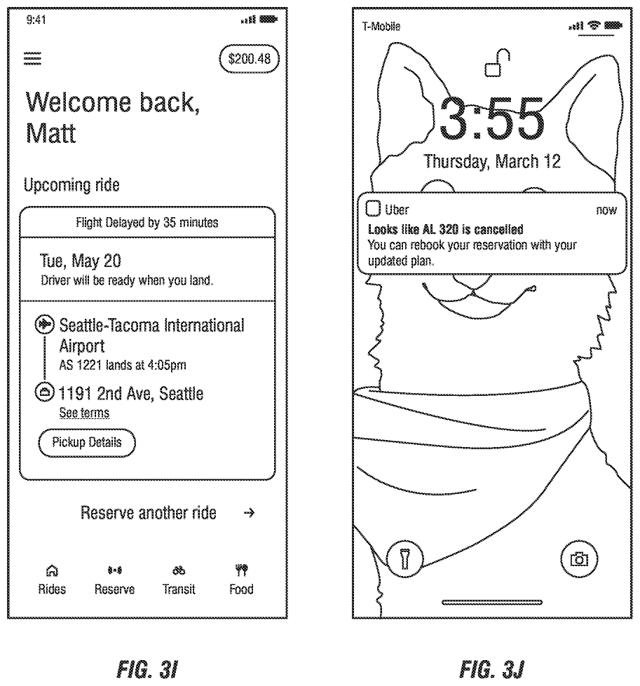

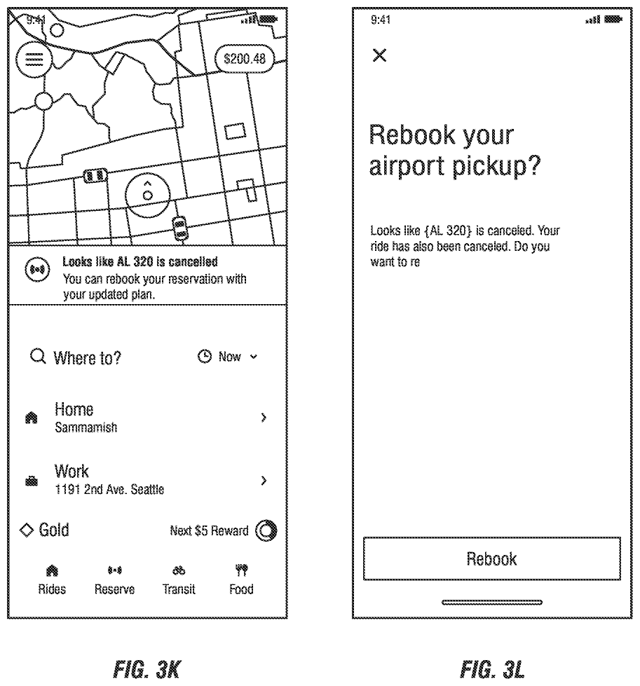

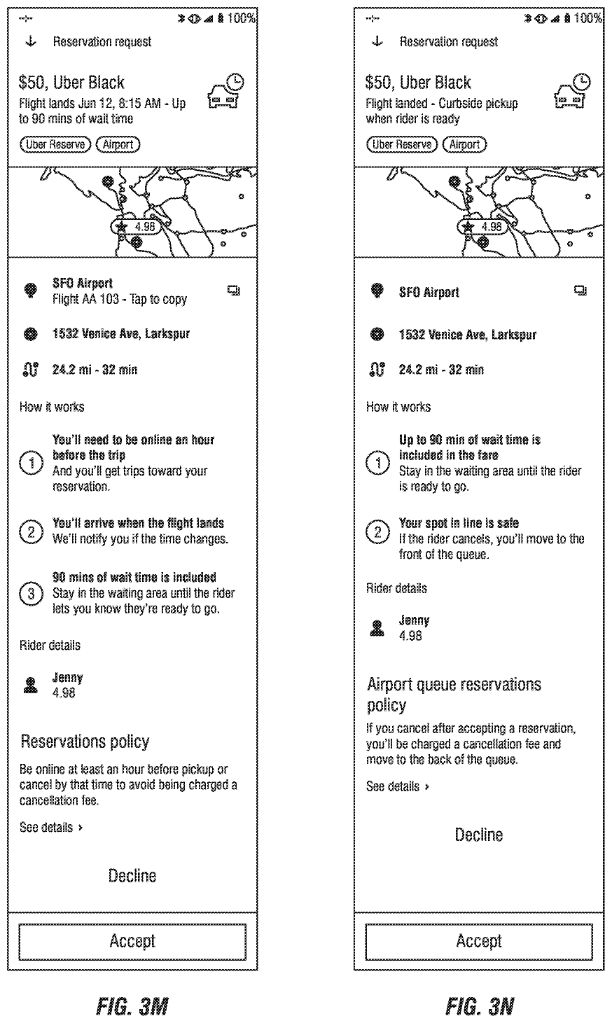

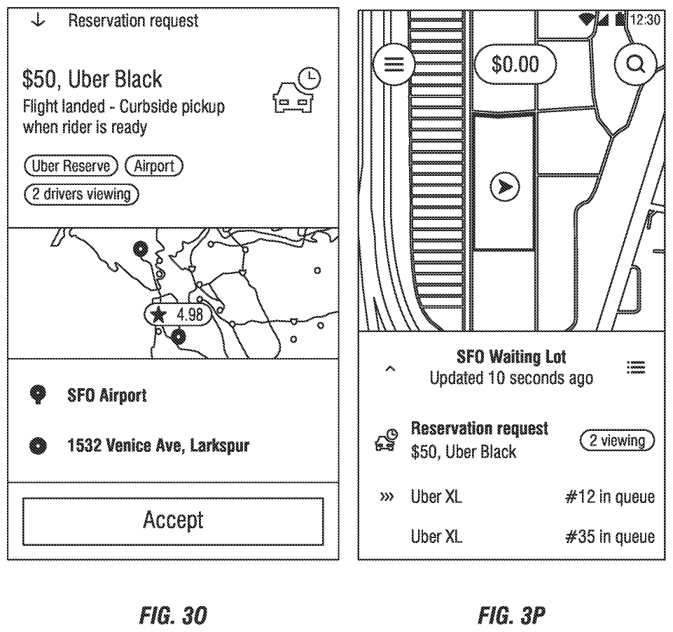

The network computer system 100 at step 2111 can identify suitable or available service providers for pre-matching to a user's transport request or service. Further, the network computer system 100 transmits data to the service provider devices of the identified service providers to cause the service provider devices to present user interfaces (e.g., offer user interfaces such as the exemplary one illustrated in FIG. 3M) that include information relating to the request such as the service time, service location, destination location, expected travel time from the service location to the destination location, distance from the service location to the destination location, the additional information input by the user (e.g., flight number), etc. If the service provider accepts the offer or invitation, the network computer system 100 can associate the service provider with the scheduled request.

At step 2112, the network computer system 100 monitors for updates relating to the user, and/or a scheduled event of the user, based on the additional information. In examples, the network computer system 100 monitors for one or more activities that are associated with the schedule event of the user. For instance, the network computer system 100 can monitor flight status information for a scheduled flight of the user. The network computer system 100 can, for example, utilize one or more program interfaces to detect changes to the scheduled flight. In this way, the network computer system 100 retrieves the latest and up-to-date information relating to the flight of the user to determine whether any mitigating steps need to be taken in response to a flight status exception (e.g., flight delay or cancellation). The network computer system 100 can do so by monitoring or periodically querying third-party data source(s).

At step 2113, the network computer system 100 can determine whether an exception (e.g., any event that may affect the user's scheduled transport service) relating to the user's scheduled transport service has taken place. Exceptions can include events detected based on the updates retrieved or received at step 2112 such as delays or cancellations (e.g., flight delay, flight cancellation, cancellation of a concert at the venue, etc.). Threshold measures can be taken such that minimal delays (e.g., delays of less than 15 minutes) can be ignored by the network computer system 100. Other exceptions can include the pre-matched service provider cancelling the pre-match with the user's scheduled request (e.g., based on input via the service provider application). Certain exceptions, such as the pre-matched service provider cancelling the pre-match, can lead to the network computer system 100 to switch the mode of operation to the queue-based mode to fulfill the scheduled request. Other exceptions can be handled by defined processes 2114 (e.g., a detected flight cancellation can trigger the cancellation of the pre-match and a notification to be presented on the user device to prompt the user to input updated flight information). In certain situations, exception handling 2114 can lead to a resolution or mitigation of the detected exception and can enable the process to proceed to step 2115. For instance, a detected delay of more than 15 minutes but less than an hour can be resolved by simply notifying the pre-matched service provider (e.g., notification on device or in-app notification); whereas a delay of more than an hour need to be resolved by prompting the service provider within the service provider application to accept an updated service time (e.g., based on the updated delay information).

At step 2115, the network computer system 100 can determine relocation parameters that include (i) an intermediate location, where the service provider is wait in advance of the transport service being initiated for the user, and (ii) an intermediate arrival time, coinciding with an approximate time when the user is to arrive at the intermediate location. Further, the network computer system 100 determines a time to surface or transmit a relocation request to the service provider device of the pre-matched service provider. In some implementations, the relocation request is surfaced or transmitted ahead of a detected event (e.g., landing of the user's flight) such that the service provider can travel to an intermediate location at approximately the time of the detected event to wait for the requesting user to be ready to receive transport services. According to embodiments, the network computer system 100 can verify, at a predetermined time prior to the scheduled service time, that the service provider is in an online or active mode with respect to the network-based transport service (e.g., entered into via the service provider application executing on the service provider device). For example, the network computer system 100 can verify an hour prior to the landing of the user's flight that the pre-matched service provider is in an online state and ready to provide transport services. Further, as described with some examples, the network computer system 100 can repeatedly or continuously monitor information about the scheduled event to update or otherwise redetermine the relocation parameters. In this way, the relocation parameters can be subject to repeated or continuous updates, based on changes to the scheduled event.

At step 2104, the network computer system 100 can transmit a relocation request to the provider device to cause the provider device to present directions (e.g., navigation directions) to the service provider to relocate to an intermediate location (e.g., an airport waiting lot) to wait for the user to be ready to receive the scheduled transport service. For example, the network computer system 100 transmits a notification to the matched or selected service provider at a time that is based on the current location of the service provider and the relocation parameters. Further, as the relocation parameters can update based on changes to the scheduled event, the time when the relocation request or notification is transmitted to the service provider can account for changes to the scheduled event. Once the service provider arrives at the intermediate location, the service provider's status can be transitioned to a waiting status and a timer indicating the minimum amount of time (e.g., 60 minutes, 90 minutes) the service provider must wait for the requesting user at the intermediate location can be counted down. If the timer expires and the user still is not ready to receive transport, the matched service provider can be presented with options to either continue waiting for the requesting user or cancel the match with the requesting user and instead join the queue of service providers associated with the service location (e.g., to service other requests for transport from other users).

At step 2105, the network computer system 100 can determine additional service details such as a precise pickup location. In some examples, the additional service details can be determined based on the additional information inputted by the user. For instance, based on the flight information inputted by the user, the network computer system 100 can identify a detailed pickup location (e.g., rideshare pickup closest to the baggage claims of the airline taken by the user, etc.), as well as a pickup time which may follow the time of the scheduled event (e.g., 10 minutes after scheduled flight arrival). At step 2106, the network computer system 100 receives an indication from the user device that the user is ready to receive transport service and can transmit a pickup request to the provider device to direct the service provider to relocate from the intermediate location to the determined precise pickup location.

In the queue mode 2120, the network computer system 100 monitors for updates at step 2121. This step can be substantially similar or the same as step 2112 performed for the pre-match mode 2110. Exceptions relating to the scheduled transport service can be identified at step 2122. Some exceptions (e.g., detected delay of the user's flight to a time of expected low supply of service providers at the service location) can cause the network computer system 100 to transition the fulfillment of the user's scheduled request in accordance with the pre-match mode 2110 if the delay is detected sufficiently in advance of the updated service time to enable the proper operation of the pre-match mode (e.g., if the delay is detected before a predetermined time window, such as 6 hours, prior to the updated flight landing time). Other exceptions can be handled by the exception handling for the queue mode 2124. At step 2123, the network computer system 100 can identify a service provider for the scheduled transport request from the queue of service providers associated with the service location at step 2123. This identification can be performed at or around the service time (or updated service time as determined at step 2121). For instance, the network computer system 100 can identify one or more service providers candidates in an airport queue to provide service for the user's scheduled request 5 minutes prior to the landing of the user's flight. Invitations or offers can be transmitted and presented to the identified service provider candidates and a single service provider in the queue can be matched to the request. Once a service provider is matched, fulfillment of the request in the queue mode 2120 can continue in the same manner with steps 2104 to 2106 as described with respect to the pre-match mode with the exception that, in certain instances, the matched service provider matched from the queue is already located at the intermediate location for waiting for users (e.g., the airport queue) and a relocation request (step 2104) is not needed.

FIG. 2B is a flowchart diagram illustrating an example pre-transport method for the pre-match mode in providing scheduled transport from an airport location, in accordance with examples described herein. In the below discussion of FIG. 2B, reference may be made to features and examples shown and described with respect to FIG. 1. For instance, the method 2200 illustrated in and described with respect to FIG. 2B can be performed by the exemplary network computer system 100 illustrated in FIG. 1. Furthermore, the method 2200 can correspond to a more detailed illustration of a portion of method 2100 of FIG. 2A.

In more detail, steps 2201, 2202, and 2203 can correspond with steps 2101, 2102, and 2111, respectively, described with respect to FIG. 2A. At step 2204, the network computer system 100 monitors for flight status of the user's flight. If a disruption is detected at step 2205, steps can be taken for mitigation or resolution of the disruption. For instance, if a minimal delay is detected (e.g., less than 15 minutes), the network computer system 100 can determine to take no mitigating steps. On the other hand, if the network computer system 100 determines that the user's flight is delayed for more than a first threshold (e.g., 15 minutes) but less than second threshold (e.g., 45 minutes, 60 minutes, etc.), the network computer system 100 can transmit an update to the pre-matched service provider to inform the pre-matched service provider of the delay. The network computer system 100 can further determine to surface the relocation request on the provider device at a later time than originally determined based on the detected delay. For lengthier delays that exceed the second threshold (e.g., more than 60 minutes), the network computer system 100 can present the pre-matched service provider with updated scheduled service information and prompt the pre-matched service provider to accept or decline the pre-match with the request based on the updated information (step 2106). If the service provider accepts 2207, the fulfillment of the request can proceed in the pre-match mode with the pre-matched service provider as illustrated in FIG. 2C. If the service provider declines the prompt, the pre-match of the scheduled request with the pre-matched service provider can be cancelled and the system can determine if it should proceed in the queue mode or in the pre-match mode at step 2208. This can be based on the updated flight arrival information. For example, there may not be sufficient time prior to the user's flight landing to proceed in the pre-match mode and the fulfillment of the user's request can proceed in the queue mode as illustrated in FIG. 2D. As another example, the updated flight arrival time can correspond to a time of high expected supply of service providers at the airport queue and the fulfillment of the user's request can proceed in the queue mode. If the fulfillment is to be provided in the pre-match mode, the network computer system 100 can identify another service provider to be pre-matched with the scheduled request (e.g., step 2203). In the event that a flight cancellation is detected at step 2205, the network computer system 100 can terminate the pre-match of the user's request with the pre-matched service provider (step 2209) and prompt the user to enter new flight information within the user application (step 2210) such that the scheduled transport service can be provisioned in light of the flight cancellation.

FIG. 2C is a flowchart diagram illustrating an example transport provision method for the pre-match mode in providing scheduled transport from a mass-egress location, in accordance with examples described herein. In the below discussion of FIG. 2C, reference may be made to features and examples shown and described with respect to FIG. 1. For instance, the method 2300 illustrated in and described with respect to FIG. 2C can be performed by the exemplary network computer system 100 illustrated in FIG. 1. Furthermore, the method 2300 can correspond to a more detailed illustration of a portion of method 2100 of FIG. 2A.

In more detail, the network computer system 100 can, at step 2301, verify that the status of the pre-matched service provider is “online” or “active” with respect to the network-based transport service. The “online” or “active” status can correspond with a status indicating that the service provider is ready to provide transport and can be entered into via a selection or input within the service provider application. In certain implementations, the network computer system 100 can make this verification a pre-determined time prior to an event time associated with the user's request (e.g., flight landing time, concert end time, train arrival time, etc.), which can be updated based on the monitoring performed by the network computer system 100. If the service provider is identified to be offline, the network computer system 100 can transmit notification data to cause one or more notifications to be presented on the device of the pre-matched service provider to remind the service provider of the scheduled service that the service provider previously accepted and prompt the service provider to enter the “online” or “active” status. According to embodiments, the network computer system 100 can further classify the service provider as unavailable to be matched with other requesting users a period of time prior to the event time such that the service provider will be available to arrive at the service location at or around the event time.

At step 2302, the network computer system 100 can transmit a relocation request to the pre-matched service provider to direct the pre-matched service provider to travel to an intermediate location (e.g., airport waiting lot). Depending on the implementation, the network computer system 100 can transmit the relocation request based on relocation parameters that include (i) an intermediate location, and (ii) a target or desired arrival time for the service provider to arrive at the intermediate location. In examples, the network computer system 100 transmits a notification (or multiple notifications) to the service provider, where the notification instructs, directs or otherwise causes the service provider to arrive at the intermediate location at approximately the time of the scheduled event.

In some implementations, the relocation parameters can provide for the target arrival time for the service provider to arrive at the intermediate location to be about the same as the time of the scheduled event (e.g., time of the user's flight landing, time of the user's train arriving, etc.). Accordingly, the relocation parameter relating to the time when the service provider is to arrive at the intermediate location may be based on the time of the scheduled event (e.g., arrival time of user's flight). In some variations, the target arrival time for the service provider to arrive at the intermediate location can vary by an offset from the time of the scheduled event (e.g., 5 or 10 minute offset between the arrival time at the intermediate location and the arrival time of the flight). Further, the determination of the offset can be based on a variety of factors, such as an estimated travel time for the service provider to travel from the intermediate location to a precise pickup location, and/or an estimated time for the user to deplane, obtain luggage, and/or arrive from the plane to the precise pickup location. Based on implementation, the determined offset can be static, or alternatively, dynamically determined based on objectives such as minimizing the driver down time and/or user wait time. Further, the offset may be determined based on one or more objectives, such as to minimize a downtime of the service provider in waiting at the intermediate location for the user to be ready for pickup, and or a wait time of the user at a pickup location within the mass egress location.

Accordingly, in examples, the offset or relative timing between when the service provider is to arrive at the intermediate location and the time of the scheduled event can be dynamically determined in accordance with one or more objectives to minimize driver downtime and/or user wait time. The network computer system 100 can separately estimate or predict (i) a duration for the service provided to travel from the intermediate location to a precise pickup location within the mass egress location, and/or (i) a duration for the user to be ready for pickup at a precise location within the mass egress location relative to the time of the scheduled event (e.g., time between when a scheduled flight of the user lands and the user arrives at the precise pickup location within the airport). When dynamically determined, the offset can be determined from historical information, contextual information and/or observed information (e.g., from determining location or position information of the service provider, user, or other service providers/users). For example, in the case of the user, the time for the user to be ready for pickup at a pickup location within the egress location can be based on user-specific historical information (e.g., how much time the user has taken in the past to be ready for pickup), location-specific or general historical information (e.g., how long other users took to deplane and be ready for pickup at the same airport), information inferred or otherwise determined about the particular scheduled event of the user (e.g., whether the user checked luggage in), contextual information such as general congestion of the mass egress location, and/or preferences of the user. Still further, in some examples, the estimated time for the user to be ready at a pickup location within the mass egress location can be based on monitoring a location or activity of the user. For example, the estimated ready time can be based in part on when the user is detected as opening the client application and/or a location of the user within the mass egress location. Similarly, a time for the service provider to travel from the intermediate location to a precise location within the mass egress location can be based on observed travel times for other drivers (between the intermediate location and a similar or same pickup location within the mass egress location), as well as contextual information such as the general congestion level of the mass egress location.

In examples, the network computer system 100 also determines a time for transmitting a notification or otherwise directing the service provider to the intermediate location. The timing of the notification can be based on an objective of having the service provider arrive at the intermediate location at the target arrival time. In examples, the network computer system 100 can continuously monitor the service provider's location and cause the relocation notification to be surfaced at a time such that the service provider will arrive at the intermediate location at the target arrival time. Accordingly, the time for the network computer system 100 to transmit the notification can be based on the relocation parameters, a current location of the service provider, and/or an updated time of the scheduled event (e.g., current arrival time of the user's scheduled flight). The service provider application can present navigation directions to the intermediate location for the service provider to follow. In accordance with examples, the determination of when the notification to the service provider is to be surfaced can be based on contextual information, such as an estimated travel time (with traffic) for the service provider to travel to the intermediate location, an estimated travel time for the service provider to travel from the intermediate location to the precise pickup location for the user, and/or an estimated travel time for the user to travel to the pickup location with the mass egress location.

At step 2303, the network computer system 100 can determine, based on location data (or a current location) transmitted by the service provider device, that the pre-matched service provider has arrived at the intermediate location. In some variations, the service provider status can be automatically entered into a waiting status and a timer can begin to be counted down (step 2304). The amount of time on the timer can correspond to a time (e.g., 60 minutes) the service provider is to wait at the intermediate location for the requesting user to be ready to receive transport. Upon expiration of the timer, the service provider can be provided a choice to either continue waiting for the requesting user or terminate the match with the requesting user and to enter the queue associated with the service location to provide transport to other users. In the event that the service provider arrives at the intermediate location prior to the event time (e.g., the flight landing time) the timer can begin at the event time. Furthermore, if the requesting user cancels the request after the service provider arrives at the intermediate location or after the service provider is enroute to the intermediate location, the service provider can also be entered the queue to provide service to other users with a priority (e.g., entered to the top of the queue to compensate for the service provider traveling to the service/intermediate location). At step 2305, the network computer system 100 determines a precise pickup location for the requesting user based on the additional information provided by the user and/or the location data transmitted by the user device. For instance, if the service location is an airport, the network computer system 100 can determine a particular pickup location within the airport (e.g., a specific rideshare pickup location designated for a particular terminal within the airport) based on the user's flight information. At step 2306, the network computer system 100 can transmit data to cause a notification to be presented on the user device notifying the user that the service provider is waiting at the intermediate location and is ready to provide transport for the user. The user can interact with the notification to cause a user interface to be presented on the user device to provide an indication that the user is ready to receive transport. The user interface can include information to the user (e.g., FIG. 3F) such as an estimated time for the service provider to travel form the intermediate location to the pickup location to rendezvous with the user. At step 2307, the network computer system 100 can receive such an indication from the user device. And in response, at step 2308, the network computer system 100 can transmit a pickup request to the service provider device of the pre-matched service provider to direct (e.g., by providing navigation directions) the service provider to the pickup location. Furthermore, at step 2309, the user device can present information and/or directions for the user to go to the pickup location.

FIG. 2D is a flowchart diagram illustrating an example transport provision method for the queue mode in providing scheduled transport from a mass-egress location, in accordance with examples described herein. In the below discussion of FIG. 2D, reference may be made to features and examples shown and described with respect to FIG. 1. For instance, the method 2400 illustrated in and described with respect to FIG. 2D can be performed by the exemplary network computer system 100 illustrated in FIG. 1. Furthermore, the method 2300 can correspond to a more detailed illustration of a portion of method 2100 of FIG. 2A.

In more detail, the network computer system 100 can identify service providers in queue associated with the mass-egress location at step 2401. Service providers can be entered into the queue based on their locations. For instance, in response to a service provider device indicating that a service provider has arrived at an airport waiting lot, the service provider can be entered into the airport queue for providing transport for users from the airport. At step 2402, the network computer system 100 can identify suitable service provider candidates from the queue and transmit offers to the service provider candidates to fulfill the scheduled transport for the requesting user. This can be performed at or around the time of event time (e.g., 5 minutes prior to the flight landing time). At step 2403, a service provider who accepted the offer or invitation can be matched with the scheduled request. At step 2404, the network computer system 100 can determine whether the matched service provider is located at the desired intermediate location for providing transport for the user. In some instances, an airport can have multiple waiting lots and there may be a waiting lot that is closer or has less ETA to the pickup location of the user. In such instances, the network computer system 100 can transmit a relocation request to the matched service provider (step 2405) and determine that the service provider has arrived at the specified or desired intermediate location (step 2406). The remainder of the method 2400 can proceed in a similar manner as described with respect to FIG. 2C. For instance, steps 2407 through 2412 can be performed in a similar manner as described with respect to steps 2304 through 2309 of FIG. 2C.

FIG. 2E is a flowchart diagram illustrating an example method for matching a service provider to a user that requires transport in connection with a scheduled event at a mass egress location, in examples described herein. In the below discussion of FIG. 2E, reference may be made to features and examples shown and described with respect to FIG. 1. For instance, the method 2500 illustrated in and described with respect to FIG. 2E can be performed by the exemplary network computer system 100 illustrated in FIG. 1. Furthermore, the method 2500 can be based on examples as described with FIG. 2A through FIG. 2D.

According to examples, at step 2501, network computer system 100 determines one or more transport service parameters for transporting a user in connection with an upcoming scheduled event at mass egress location. The one or more service parameters can include a pickup time when a transport service is to initiate for the user. In variations, the pickup time can correspond to the scheduled time, a time that is different than but based on the time of the scheduled event, or a specified time (e.g., by user).

At step 2502, the network computer system 100 monitors one or more activities associated with the scheduled event to determine whether to update the one or more transport service parameters, including the pickup time. Further, the pickup time can be updated if warranted, in response to a determination that the time of the scheduled event has changed.

In examples, the network computer system 100 can utilize one or more programmatic interfaces that are associated with or otherwise communicate information about the scheduled event to determine the timing or location of the scheduled event changes. For instance, the network computer system 100 interfaces with one or more flight services to repeatedly or continuously check the arrival or departure time of a scheduled flight of the user. In other examples, the network computer system 100 monitors activities of the user, as detected through an application executing on the user computing device, to detect a change to the scheduled plan. For example, the user's calendar (e.g., as obtained through a calendar application) can be monitored to determine if other events are entered by the user which may warrant change to the transport service which the user may request in connection with the scheduled event. Still further, sensors of the user computing device can be monitored to detect whether such changes are needed. For example, the sensor information (e.g., user location information) can indicate the user missing the scheduled flight and/or the user taking an alternative flight. In the latter case, the change to the scheduled event (e.g., user arrival to home city) can include change of scheduled time (e.g., new flight arrival time) and/or change to the intermediate location (e.g., change to terminal of airport).

At step 2503, a first service provider is selected to transport the user from the mass egress location, in connection with the scheduled event of the user. In such examples, the service provider can be selected to transport the user in advance of the user affirmatively or explicitly making a transport request.

At step 2504, a set of relocation parameters are determined in connection with the transport service that is to be provided to the user. The set of relocation parameters can be based at least in part on the determined transport parameters. The set of relocation parameters can include (i) an intermediate location where the service provider is to be located to provide the user with the transport service, and (ii) an intermediate arrival time when the first service provider is to arrive at the intermediate location before the pickup time. In some examples, the intermediate location can correspond to a waiting area. Further, the intermediate arrival time can be based on the time of the scheduled event (e.g., arrival time of user's scheduled flight). In some implementations, the intermediate arrival time can further be defined by a range. Further, the determination of the relocation parameters can be implemented in accordance with step 2302.

At step 2505, the network computer system 100 determines a relocation time when the service provider is to initiate travel to the intermediate location. The relocation time can be based at least in part on a current location of the service provider, the intermediate arrival time, and other conditions (e.g., traffic, weather, or other factors).

At step 2506, the network computer system 100 transmits, at the determined relocation time, a first notification or other communication to a computing device of the service provider, in order to cause the service provider to begin traveling towards the intermediate location.

At step 2507, the network computer system 100 transmits a second notification to the computing device of the first service provider to direct the first service provider from the intermediate location to a pickup location within the mass egress location, to initiate the transport service from mass egress location. For instance, the pickup location within the egress location can specify a terminal, door or other landmark within an airport. The timing of the second notification can be based at least in part on the pickup time (which may be updated, based on the determination of step 2502).

### User Interface Examples

FIGS. 3A through 3P illustrate example user interfaces displayed within the user application and the service provider application to facilitate the request and fulfillment of scheduled transport services from mass-egress locations, in accordance with examples described herein.

FIGS. 3A and 3B illustrate example user interfaces presented within the user application to enter additional information such as the date of a flight (FIG. 3A) and the flight number of the flight (FIG. 3B). FIG. 3C illustrate a confirmation user interface presented within the user application after completion of a request for a scheduled transport service from a mass-egress location. FIG. 3D illustrate an information user interface informing the user the details of the scheduled transport service.

FIG. 3E illustrate an example push notification presented by the user device informing the user that a matched service provider has arrived at the intermediate location (e.g., airport waiting lot) and is ready to fulfill the scheduled transport for the user. The push notification includes information relating to an amount of time the service provider is scheduled to wait for the user at the intermediate location. FIG. 3F illustrates a user interface presented within the user application for providing an indication that the user is ready to receive transport service. The user interface includes an indication of an ETA (e.g., “8 minutes”) for the service provider to travel from the intermediate location to the precise pickup location for the user (e.g., “Terminal 2 Door 8”). The user interface further includes a selectable feature for providing an indication that the user is ready to receive transport service (e.g., “Yes, pick me up”). Furthermore, the user interface includes features for contacting the service provider who is matched with the user's request and includes options to message or call the service provider. FIG. 3G illustrates a user interface presented within the user application for providing information and directions for the user in arriving at the pickup location and for identifying the vehicle operated by the service provider.

FIG. 3H illustrates an example notification for presentation by the user device in notifying the user of a detected flight delay associated with the user's transport request. FIG. 3I illustrates a user interface presented within the user application for providing information relating to a detected flight delay. For instance, in response to the user selecting or interacting with the notification presented in FIG. 3H, the user application can present the user interface illustrated in FIG. 3I.

FIG. 3J illustrates an example notification for presentation by the user device in notifying the user of a detected flight cancellation associated with the user's transport request. FIG. 3K illustrates a user interface presented within the user application for providing information relating to a detected flight cancellation. For instance, in response to the user selecting or interacting with the notification presented in FIG. 3J, the user application can present the user interface illustrated in FIG. 3K. The user interface in FIG. 3K can indicate that the scheduled transport service has been terminated and the user can be prompted to enter updated flight details (e.g., new flight number) within the user application. For instance, by tapping on the are of the user interface that includes the cancellation information, the user can be prompted with the user interface illustrated in FIG. 3L to rebook the scheduled transport service with a new flight number.

FIG. 3M illustrates an example user interface presented by the service provider application for presenting an invitation or offer to pre-match (e.g., in accordance with the pre-match mode) with a request for scheduled transport from a mass-egress location. FIG. 3N illustrates an example user interface presented by the service provider application for presenting an invitation or offer to match in the queue mode with a request for scheduled transport from a mass-egress location.

FIG. 3O illustrates another example user interface presented by the service provider application for presenting an invitation or offer to match in the queue mode (or queue matching process) with a request for scheduled transport from a mass-egress location. When the queue matching process is implemented, multiple service providers may be co-located within a given region (e.g., waiting region adjacent to mass egress location) and each service provider can be associated with a priority order that is based on a time when the particular service provider entered a designated region associated with the mass egress location. For example, the designated region can be a geofenced region about a mass egress location, such as an airport. In this way, the queue matching process can implement a queue, where each service provider that is identified within the queue is provided a priority order in accordance with a priority schema of the queue (e.g., first-in, first-out priority).

As illustrated by examples, the user interface illustrated in FIG. 3O can provide an indication of how many other service providers in the queue are viewing the offer or invitation. In some examples, the number of persons who view an offer can correspond to those service providers who were sent invitations. In accordance with some examples, a set of service providers who receive the invitation under the queue matching process can be selected, based on their priority position in the queue. In specific examples, invitations can be communicated based on an inverse priority designation of the queue, meaning service providers that have the lowest priority designation may receive the invitation before or over other service providers in the queue. For example, the invitation can be communicated to service providers who have the lowest priority in the queue (e.g., last service provider(s) to enter the queue), or alternatively, to those service providers who do not have the highest priority within the queue (e.g., service providers with the highest priority other than those service providers who will be imminently dispatched). By communicating invitations to the lowest priority service providers, the network computer system 100 can offer the use of the greatest range of time for becoming ready for pickup at the mass egress location. Service provider who receive invitations can (i) dismiss or decline the invitations, (ii) take no action, or (iii) accept the invitation. In examples, once a service provider declines the invitation, network computer system 100 updates the presentation on the computing devices of the service providers who may still consider the invitation to reflect one less viewer of the invitation. Likewise, the network computer system 100 may communicate the offer to additional participants, such as newly received participants in the queue, or other participants who may have a higher priority designation within the queue. In this way, the number of participants who are viewing an offer can increase or decrease over time, until one of the service providers accepts the offer of the invitation.

FIG. 3P illustrates an example user interface presented by the service provider application for displaying additional information for the service provider after receiving an offer or invitation to fulfill a scheduled transport service in the queue mode. For instance, the user interface illustrated in FIG. 3P can provide an indication of the service provider's current place in the queue associated with the mass-egress location. Such information can enable the service provider to make an informed decision with respect to whether to continue waiting in the queue or to accept the invitation.

Hardware Diagrams

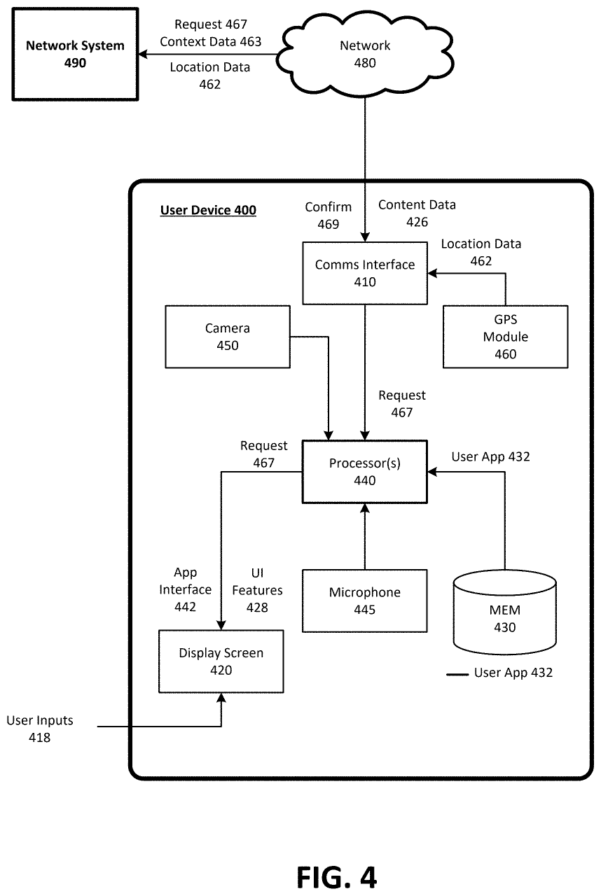

FIG. 4 is a block diagram illustrating an example user device executing and operating a designated user application for communicating with a network computer system 100, according to examples described herein. In many implementations, the user device 400 can comprise a mobile computing device, such as a smartphone, tablet computer, laptop computer, VR or AR headset device, and the like. As such, the user device 400 can include typical telephony features such as a microphone 445, a camera 450, and a communication interface 410 to communicate with external entities using any number of wireless communication protocols. In certain aspects, the user device 400 can store a designated application (e.g., a user application 432) in a local memory 430. In variations, the memory 430 can store additional applications executable by one or more processors 440 of the user device 400, enabling access and interaction with one or more host servers over one or more networks 480.

In response to a user input 418, the user application 432 can be executed by a processor 440, which can cause an application interface 442 to be generated on a display screen 420 of the user device 400. The application interface 442 can enable the user to, for example, check current value levels and availability for the network service. In various implementations, the application interface 442 can further enable the user to select from multiple service types.

The user can generate a service request 467 via user inputs 418 provided on the application interface 442. For example, the user can select a start location, view the various service types and estimated costs, and select a particular service to an inputted destination. In many examples, the user can input the destination prior to pick-up. As provided herein, the user application 432 can further enable a communication link with a network system 490 over the network 480, such as the network computer system 100 as shown and described with respect to FIG. 1. The processor 440 can generate user interface features 428 (e.g., map, trip progress bar, content cards, etc.) using content data 426 received from the network system 490 over network 480. Furthermore, as discussed herein, the user application 432 can enable the network system 490 to cause the generated user interface features 428 to be displayed on the application interface 442.

The processor 440 can transmit the service requests 467 via a communications interface 410 to the backend network system 490 over a network 480. In response, the user device 400 can receive a confirmation 469 from the network system 490 indicating the selected service provider and vehicle that will fulfill the service request 467 and rendezvous with the user at the start location. In various examples, the user device 400 can further include a GPS module 460, which can provide location data 462 indicating the current location of the requesting user to the network system 490 to, for example, establish the start location and/or select an optimal service provider or autonomous vehicle to service the request 467.

In certain implementations, the user device 400 is configured to generate and transmit, to the network system 490, context data 463 that can be used by the network system to determine a propensity of the user who operates the user device 400 to perform an action via the user application 432. The context data 463 can include user application interaction data indicating interactions, inputs, selections, or a degree of progress through a particular user interface flow (e.g., a user interface flow to submit a service request). The context data 463 can further include sensor data such as barometer or elevation data, ambient light sensor data, accelerometer data, gyroscope data, location data 462, and the like. The context data 463 can further include user application status data indicating, for example, whether the user application 432 is executing as a background process or as a foreground process on the user device 400. The user application status data can further indicate a duration of time the user application 432 has been executing as a foreground process or a duration of time the user application 432 has been executing as a background process. Using the context data 463, the network system 490 can determine, using one or more context models, a propensity of the user to, for example, submit a service request within the next 2 minutes, or cancel a submitted service request 467 once the user is matched by the network system 490 with a service provider in response to the service request 467.

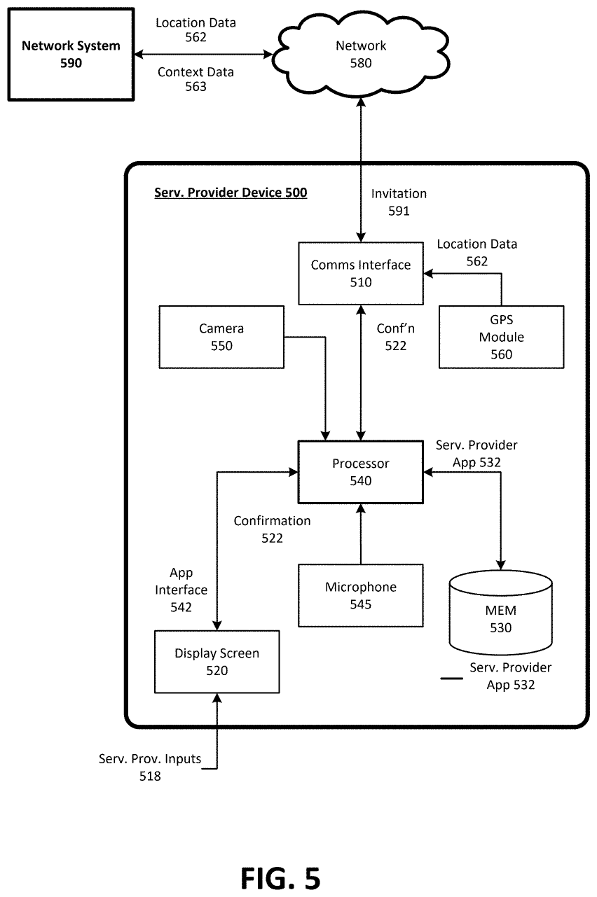

FIG. 5 is a block diagram illustrating an example service provider device executing and operating a designated service provider application for communicating with a network service, according to examples described herein. In many implementations, the service provider device 500 can comprise a mobile computing device, such as a smartphone, tablet computer, laptop computer, VR or AR headset device, and the like. As such, the service provider device 500 can include typical telephony features such as a microphone 545, a camera 550, and a communication interface 510 to communicate with external entities using any number of wireless communication protocols. The service provider device 500 can store a designated application (e.g., a service provider app 532) in a local memory 530. In response to a service provider input 518, the service provider app 532 can be executed by a processor 540, which can cause an app interface 542 to be generated on a display screen 520 of the service provider device 500. The app interface 542 can enable the service provider to, for example, accept or reject invitations 592 in order to service requests throughout a given region.

In certain implementations, the service provider device 500 is configured to generate and transmit, to the network system 590, context data 563 that can be used by the network system to determine a propensity of the service provider who operates the service provider device 500 to perform an action via the service provider application 532. The context data 563 can include service provider application interaction data indicating interactions or inputs of the service provider with the service provider application 532. The context data 563 can further include sensor data such accelerometer data, gyroscope data, e-compass data, and the like. In certain implementations, the network system 590 can further utilize location data 562 as context data in making certain determinations. Using the context data 563, the network system 590 can determine, using one or more context models, a propensity of the service provider to, for example, decline an invitation corresponding to a service request form a user or cancel an acceptance after the service provider has accepted the invitation.

In various examples, the service provider device 500 can include a GPS module 560, which can provide location data 562 indicating the current location of the service provider to the network system 590 over a network 580. The network system 590 can determine whether the service provider operating service provider device 500 is a suitable match for a particular request. In this determination, the network system 590 can compute a matching parameter for the service provider based on the location data 562 and other data, including context data 563, which can be a predictive indicator of how suitable the service provider is for fulfilling a particular service request. Furthermore, in determining whether the service provider should be matched with the particular request, the network system 590 can determine a mode of operation (e.g., exclusive-invite mode vs. multi-invite mode) and a presentation mode for presenting information relating to the invitation and/or the request (e.g., an active multi-invite presentation vs. a passive multi-invite presentation mode).

In response to the service provider being determined as a match for the particular request (e.g., either an exclusive match in the exclusive-invite mode or one of a plurality of matches in the multi-invite mode), the network system 590 transmits an invitation 591 relating to the particular request to the service provider device 500. In response to receiving the invitation 591, the service provider device 500 can present information relating to the invitation 591 and/or the particular request on the display screen 520. Receipt of the invitation 591 can also trigger an audio notification. The information relating to the invitation and/or particular request can be presented in accordance to the determined mode of operation and/or the presentation mode. In some implementations, the information can be presented in distinct manners based on (i) the invitation 591 being an exclusive-mode invitation, (ii) the mode of presentation of the invitation 591 being determined for the service provider as the active multi-invite presentation mode, and/or (iii) the mode of presentation of the invitation 591 being determined for the service provider as the passive multi-invite presentation mode. The service provider can interact with the service provider application 532 to accept or decline the invitation 591.

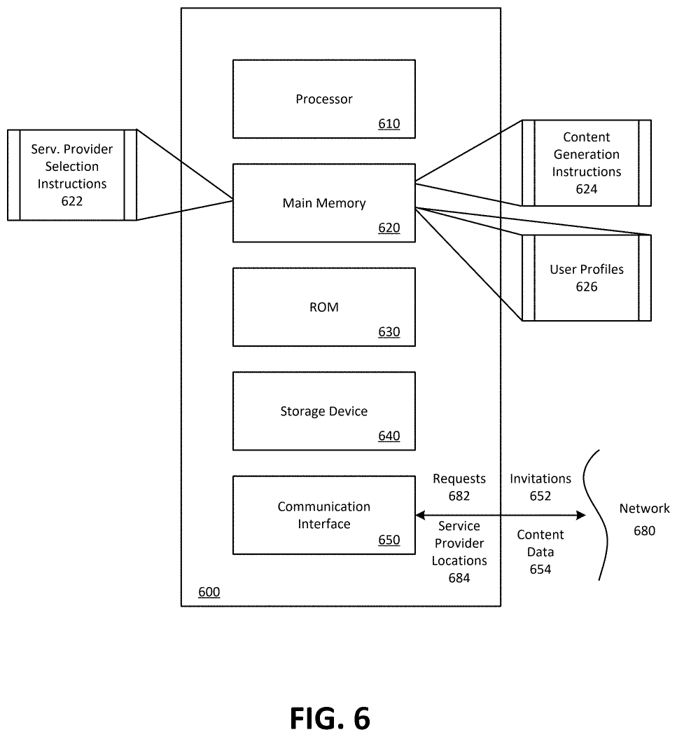

FIG. 6 is a block diagram that illustrates a computer system upon which examples described herein may be implemented. A computer system 600 can be implemented on, for example, a server or combination of servers. For example, the computer system 600 may be implemented as part of a network service, such as described in FIGS. 1 through 6. In the context of FIG. 1, the computer system 600 may be implemented using a computer system 600 such as described by FIG. 6. The computer system 100 may also be implemented using a combination of multiple computer systems as described in connection with FIG. 6.

In one implementation, the computer system 600 includes processing resources 610, a main memory 620, a read-only memory (ROM) 630, a storage device 640, and a communication interface 650. The computer system 600 includes at least one processor 610 for processing information stored in the main memory 620, such as provided by a random access memory (RAM) or other dynamic storage device, for storing information and instructions which are executable by the processor 610. The main memory 620 also may be used for storing temporary variables or other intermediate information during execution of instructions to be executed by the processor 610. The computer system 600 may also include the ROM 630 or other static storage device for storing static information and instructions for the processor 610. A storage device 640, such as a magnetic disk or optical disk, is provided for storing information and instructions.

The communication interface 650 enables the computer system 600 to communicate with one or more networks 680 (e.g., cellular network) through use of the network link (wireless or wired). Using the network link, the computer system 600 can communicate with one or more computing devices, one or more servers, and/or one or more self-driving vehicles. In accordance with examples, the computer system 600 receives requests 682 from mobile computing devices of individual users. The executable instructions stored in the memory 630 can include service provider selection instructions 622, which the processor 610 executes to select a service provider to service the request 682. In doing so, the computer system can receive service provider locations 684 of service providers operating throughout the given region, and the processor can execute the service provider selection instructions 622 to identify a plurality of candidate service providers and transmit invitation messages 652 to each of the candidate service providers to enable the service providers to accept or decline the invitations. The processor can further execute the service provider selection instructions 622 to select a service provider among interested candidate service providers to service the request 682.

The executable instructions stored in the memory 620 can also include content generation instructions 624, which enable the computer system 600 to access user profiles 626 and other user information in order to select and/or generate user content 654 for display on the user devices. As described throughout, user content 654 can be generated based on information pertaining to the state of the request (e.g., ETA/destination info). By way of example, the instructions and data stored in the memory 620 can be executed by the processor 610 to implement an example network computer system 100 of FIG. 1. In performing the operations, the processor 610 can receive requests 682 and service provider locations 684, and submit invitation messages 652 to facilitate the servicing of the requests 682. The processor 610 is configured with software and/or other logic to perform one or more processes, steps and other functions described with implementations, such as described by FIGS. 1 through 2E, and elsewhere in the present application.

Examples described herein are related to the use of the computer system 600 for implementing the techniques described herein. According to one example, those techniques are performed by the computer system 600 in response to the processor 610 executing one or more sequences of one or more instructions contained in the main memory 620. Such instructions may be read into the main memory 620 from another machine-readable medium, such as the storage device 640. Execution of the sequences of instructions contained in the main memory 620 causes the processor 610 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

1. A network computer system comprising:
one or more processors;
a memory to store instructions;
wherein the one or more processes execute the instructions stored in the memory to perform operations that comprise:
determining one or more transport service parameters for an upcoming scheduled event at a mass egress location, the one or more service parameters including a pickup time when a transport service is to initiate for the user;
monitoring one or more activities associated with the scheduled event to determine whether to update the one or more transport service parameters, including the pickup time;
selecting a first service provider to transport the user from the mass egress location in connection with the upcoming scheduled event;
determining, based at least in part on the one or more transport parameters, a set of relocation parameters, the set of relocation parameters including (i) an intermediate location where the service provider is to be located to provide the user with the transport service, and (ii) an intermediate arrival time when the first service provider is to arrive at the intermediate location before the pickup time;
determining, based at least in part on a current location of the first service provider and the intermediate arrival time, a relocation time when the service provider is to initiate travel to the intermediate location;
transmitting, at the relocation time, a first notification to a computing device of the first service provider to direct the first service provider to the intermediate location; and
transmitting, based at least in part on the pickup time, a second notification to the computing device of the first service provider to direct the first service provider from the intermediate location to a pickup location within the mass egress location, to initiate the transport service from mass egress location.

2. The computer system of claim 1, wherein the operations include:
monitoring a status or location of the user within the mass egress location to update one or more of the transport parameters.

3. The computer system of claim 1, wherein monitoring one or more activities associated with the scheduled event includes:
utilizing one or more program interfaces to detect changes to the scheduled event, and
automatically updating the pickup time in response to detecting a change to the scheduled event.

4. The computer system of claim 1, wherein monitoring the one or more activities associated with the scheduled event includes monitoring a location of the user.

5. The computer system of claim 1, wherein determining the one or more service parameters for the scheduled event includes inferring the one or more service parameters for the scheduled event, based on a preceding or subsequent transport event.

6. The computer system of claim 1, wherein determining the set of relocation parameters is based on minimizing a wait time of the user.

7. The computer system of claim 1, wherein determining the set of relocation parameters is based on minimizing a downtime of the first service provider.

8. The computer system of claim 1, wherein the operations further comprise:
predicting a provisioning level of service providers for the mass egress location during the scheduled event.

9. The computer system of claim 1, wherein the first service provider includes implementing a pre-match matching process based on the predicted provisioning level.

10. A network computer system comprising:
one or more processors;
a memory to store instructions;
wherein the one or more processes execute the instructions stored in the memory to perform operations that comprise:
determining one or more transport service parameters for an upcoming scheduled event at a mass egress location, the one or more service parameters including a pickup time when a transport service is to initiate for the user;
predicting a provisioning level of service providers for the mass egress location during a time interval of the scheduled event;
selecting one of a pre-match matching process or a queue matching process to match the transport service to one of a plurality of service providers, wherein selecting the one of the pre-match matching process or the queue matching process is based at least in part on the predicted provisioning level;
detecting the matched transport provider being positioned at an intermediate location in advance of the start time; and
transmitting a notification to a computing device of the matched service provider, to direct the matched service provider from the intermediate location to a pickup location within the mass egress location.

11. The computer system of claim 10, wherein the operations include:
implementing the queue matching process by (i) selecting a set of service providers that have a low queue priority position, and (ii) transmitting an invitation that identifies the transport event to the set of service providers.

12. The computer system of claim 11, wherein transmitting the invitation includes indicating, with the invitation to each service provider of the set, a number of service providers who are viewing the invitation.

13. A non-transitory computer-readable medium that stores instructions, which when executed by one or more processors of a network computer system, cause the network computer system to perform operations that include:
determining one or more transport service parameters for an upcoming scheduled event at a mass egress location, the one or more service parameters including a pickup time when a transport service is to initiate for the user;
monitoring one or more activities associated with the scheduled event to determine whether to update the one or more transport service parameters, including the pickup time;
selecting a first service provider to transport the user from the mass egress location in connection with the upcoming scheduled event;
determining, based at least in part on the one or more transport parameters, a set of relocation parameters, the set of relocation parameters including (i) an intermediate location where the service provider is to be located to provide the user with the transport service, and (ii) an intermediate arrival time when the first service provider is to arrive at the intermediate location before the pickup time;
determining, based at least in part on a current location of the first service provider and the intermediate arrival time, a relocation time when the service provider is to initiate travel to the intermediate location;
transmitting, at the relocation time, a first notification to a computing device of the first service provider to direct the first service provider to the intermediate location; and
transmitting, based at least in part on the pickup time, a second notification to the computing device of the first service provider to direct the first service provider from the intermediate location to a pickup location within the mass egress location, to initiate the transport service from mass egress location.

14. The non-transitory computer-readable medium of claim 13, wherein the operations include:
monitoring a status or location of the user within the mass egress location to update one or more of the transport parameters.

15. The non-transitory computer-readable medium of claim 14, wherein monitoring one or more activities associated with the scheduled event includes utilizing one or more program interfaces to detect changes to the scheduled event, and automatically updating the pickup time in response to detecting a change to the scheduled event.

16. The non-transitory computer-readable medium of claim 13, wherein monitoring the one or more activities associated with the scheduled event includes monitoring a location of the user.

17. The non-transitory computer-readable medium of claim 13, wherein determining the set of relocation parameters is based on minimizing a wait time of the user.

18. The non-transitory computer-readable medium of claim 13, wherein determining the set of relocation parameters is based on minimizing a downtime of the first service provider.

19. The non-transitory computer-readable medium of claim 13, wherein the operations further comprise:
predicting a provisioning level of service providers for the mass egress location during the scheduled event.

20. The non-transitory computer-readable medium of claim 19, wherein the first service provider includes implementing a pre-match matching process based on the predicted provisioning level.
